(19) United States
(12) Patent Application Publication
(10) Pub. No.: US 2020/0387874 A1
(43) Pub. Date: Dec. 10, 2020

(54) MULTI-OPERATOR DIRECT PAYMENT SYSTEM OF PUBLIC OPERATING SERVICE PLATFORM FOR ELECTRIC VEHICLES

(71) Applicant: STATE GRID ZHEJIANG ELECTRIC VEHICLE SERVICE COMPANY, LTD., Hangzhou, Zhejiang (CN)

(72) Inventors: Feng CHEN, Hangzhou (CN); Jian LYU, Hangzhou (CN); Bo LI, Hangzhou (CN); Liang LI, Hangzhou (CN); Jingyun CHEN, Hangzhou (CN); Yuan LI, Hangzhou (CN); Yanwei LI, Hangzhou (CN); Luyu HAN, Hangzhou (CN); Yanjiao ZHAN, Hangzhou (CN); Jie LUAN, Hangzhou (CN); Chaojun ZHENG, Hangzhou (CN)

(21) Appl. No.: 16/772,499

(22) PCT Filed: Jan. 19, 2020
(86) PCT No.: PCT/CN2020/073050

§ 371 Date: Jun. 12, 2020

(30) Foreign Application Priority Data
Nov. 21, 2018 (CN) 201811394572.7

(51) Int. Cl. G06Q 20/02; G06Q 50/30; G06Q 50/26; G06Q 20/08; G06Q 30/00; G06Q 30/06; G06Q 20/32; G06Q 20/28; G06Q 40/00; G06Q 30/04; G06Q 20/38; G06Q 20/40; G06F 16/9535; H04L 9/32; H04L 9/30; B60L 53/66

(52) U.S. Cl. CPC G06Q 20/02; H04L 2209/56; G06Q 50/26; G06Q 20/085; G06Q 30/0185; G06Q 30/0633; G06Q 20/3267; G06Q 20/28; G06Q 40/125; G06Q 30/04; G06Q 20/38215; G06Q 20/407; G06Q 20/3829; G06F 16/9535; H04L 9/3268; H04L 9/302; B60L 53/665; G06Q 2240/00; G06Q 2220/00; G06Q 50/30

(57) ABSTRACT

Disclosed in the present invention is a multi-operator direct payment system of a public operating service platform for electric vehicles, which belongs to the technical field of electric vehicle operation. The multi-operator direct payment refers to a payment method for the operators where the platform is hosted for the multiple operators. The multi-operator direct payment allows the payment to be directly paid to the actual charging account of the operators through dynamically-targeted payment techniques, without the need for secondary clearing and settlement, which also improves the timeliness of fund arrival, further achieves and promotes the interconnection among the multiple operators. In the traditional operating mode, the money firstly arrives at the platform and is then transferred to the operators, causing the problems of slow fund arrival, extra fees for transfer, and being not subject to the operators' control. The operator direct payment technology focuses on small and micro operators, where the money is directly transferred to the operator's account without going through the platform, then the money can be received in real time without the needs to pay extra fees; furthermore, there is also no concern that the platform does not give the received fees to the operators. The technical solutions according to embodiment of the present disclosure can attract more operators to join in the public management platform for charging piles, such that the charging platform of the electric vehicles can better serve the users and the operators.

### TECHNICAL FIELD

The present disclosure relates to a multi-operator direct payment system of a public operating service platform for electric vehicles, and belongs to the technical field of electric vehicle operation.

### BACKGROUND

About one third of the more than 2 million electric vehicles in operation around the world are running on the roads of China in 2016. According to the data from 2017 Global Electric Vehicle Outlook Report released by the International Energy Agency, China has become the world's largest electric vehicle market, accounting for more than 40% of the world's sales, which is significantly ahead of the United States. Thus, the explosive growth of electric vehicles has led to the rapid development of charging piles as supporting facilities.

Applications (APPs) related to the charging piles are a standard configuration for current owners of new energy vehicles. The new energy vehicle owners use the APPs related to the charging piles to find piles, charge and pay. According to statistics, users having installed the APPs related to the charging piles are about 8.8 in ten thousand (that is, the penetration rate of the users of the APPs related to the charging piles) of the total mobile Internet users. There are 1.25 billion mobile Internet users, and thus 1.1 million charging pile users in China, which means the market of the charging piles has high market growth potential.

Currently, each operator of the charging piles is only for their own array, with non-uniform charging methods (including the method of starting the charging), and non-uniform methods for charging and settlement. Furthermore, the charging cards from respective operators are non-universal and the location information about the charging piles from respective operators cannot be shared. These problems cause a large number of charging piles to be idle, which severely hinders the development of electric vehicles. Therefore, constructing a new ecology of intelligent charging stations, and creating intelligent and innovative charging management platforms are important to promote the development of electric vehicles.

The interconnected public management platform is joined by multiple operators, and provides the operators with diversion of users in terms of services for the operators and the vehicle owners, which can improve the operation efficiency of charging facilities, feed back the operation and maintenance problems of station sites regularly, realize operation and maintenance linkage with the operators, and improve the comprehensive service level of the charging station sites. The public management platform is committed to offering the vehicle owners the charging experience with accurate information and convenient payment, such that the vehicle owners can get the most convenient charging experience. During the entire service, it is necessary for the interconnected public management platform to provide the operators with the services, such as charging pile access, charging pile joint adjustment, operation and maintenance for the station sites, and payment settlement; and to provide the vehicle owners with the services such as charging pile settlement, charging start-stop, and charging settlement.

Among many services, the operators pay most attention to the payment settlement between the platform and themselves. Traditionally, the fees paid by the users firstly come to the platform, and then the platform settles with the operators, so the platform needs to open an Alipay & WeChat settlement account in the name of the management platform company, and then link it to the bank account of the company, which can realize the fund settlement process between the third-party settlement account and the company's bank account. The business department regularly transfers the payment from the third-party settlement platform to the company's bank account, and provides the corresponding details of the carryforward amount as the basis of account posting; when making payment to the suppliers, the company transfers the payment to the third-party payment platform according to the details of the amount that should be paid to the suppliers provided by a business system and after verification, and the business platform sets up a transaction control port, which is open to the suppliers for transfer within a certain period of time. In order to maintain consistency between the accounting department and the business platform, the amount of money that the suppliers has not withdrawn this time will no longer be written off as the amount already paid to the suppliers, but will be transferred from the third-party payment account back to the company account, that is, the bank deposit fails to be paid. During the settlement process between the platform and the operators, there will be at least two transaction fees: the first fee is generated since Alipay and WeChat need to charge corresponding fee when the money is transferred from WeChat and Alipay to the bank account; and the second fee is the corresponding transaction fee that is generated during the settlement and transfer between the platform and the operators.

The entire process not only involves high transaction fees, but also needs a large investment in personnel and involves complex procedures. Moreover, it has high requirements for the financial design of the public management platform, which increases the cost and difficulty of clearing and settlement. If the payment for the order is directly paid by the user to the platform, and the platform settles with the operators over a period of time, it will generate transaction fees, as well as take a long settlement time causing a loss to the cash flow of the operators. In addition, the public management platform will also have its investment in the labor and material costs increased for money management, due to the presence of multiple operators. Thus, the most urgent need in attracting the operators to join in the public management platform is to solve the settlement problem of the interconnected public management platform.

### SUMMARY

In view of the disadvantages of the prior art, the present disclosure is intended to provide a payment mode that is convenient for the charging users of electric vehicles to pay the amount of the order placed on the public management platform of the charging pile directly to the operator's account, which attracts more operators to join in the public management platform for charging piles, such that the charging platform of the electric vehicles provides a multi-operator direct payment system of a public operating service platform for electric vehicles, which better serves the users and the operators.

To this end, the technical solutions of the present disclosure are implemented as follows.

Provided is a multi-operator direct payment system of a public operating service platform for electric vehicles, including the following operations:

an operation 1 of accessing, by operators, the public platform;

an operation 2 of placing, by users, orders on different charging piles after the operators access the public operating service platform, money related to each order being directly paid to an account of a corresponding operator;

an operation 3 of performing financial management of the operators;

an operation 4 of settling with the operators.

The multi-operator direct payment according to embodiments of the disclosure refers to a payment method for the operators where the platform is hosted for the multiple operators. The multi-operator direct payment allows the payment to be directly paid to the actual charging account of the operators through dynamically-targeted payment techniques, without the need for secondary clearing and settlement, which also improves the timeliness of fund arrival, further achieves and promotes the interconnection among the multiple operators. In the traditional operating mode, the money firstly arrives at the platform and is then transferred to the operators, causing the problems of slow fund arrival, extra fees for transfer, and being not subject to the operators' control. The operator direct payment technology focuses on small and micro operators, where the money is directly transferred to the operator's account without going through the platform, then the money can be received in real time without the needs to pay extra fees; furthermore, there is also no concern that the platform does not give the received fees to the operators. The technical solutions according to embodiment of the present disclosure can attract more operators to join in the public management platform for charging piles, such that the charging platform of the electric vehicles can better serve the users and the operators.

According to some embodiments, the operation 1 includes:

(1) data reviewing, which specifically include:

when each operator accesses the platform, firstly submitting, by the operator, relevant data about the operator's enterprise, such as business license, account opening permit, a number of charging stations and locations of charging stations, to staff of a public management platform; after the relevant data is reviewed and approved by the staff of the public management platform, establishing a management unit belonging to the operator through a public management platform background system for electric vehicles, wherein the management unit is unique, and only one management unit can be established for one operator;

(2) charging station accessing, which specifically include:

after the operator accesses the platform, inputting, by the operator, relevant information about the charging stations through the public management platform background system;

firstly selecting, by the operator, a management unit to associate the charging stations with the selected management unit;

inputting, by the operator, names of station sites to distinguish different station sites of the operator;

inputting, by the operator, position information of the charging stations after information about interested party of the station site is input, wherein latitude, longitude and detailed address of the charging stations must be accurate to ensure accuracy of a map for charging stations;

after establishment of the charging stations, setting the charging piles through a pile management function, so that a user can find the charging pile and place an order for charging through an application (APP) on a mobile phone of the user;

(3) binding of the operator and the management unit, which specifically include:

finishing the access of the management unit and the charging piles, adding the operator into the public platform, and associating the operator with the management unit.

The process of the operator accessing the public platform in the present disclosure includes the data review for the operators, the charging station access, and the binding of the operator and the management unit. The technical solution of the present disclosure is complete, detailed, practical, and easy to be implemented.

According to some embodiments, the station sites should be named according to the following principles:

1. regional uniqueness

the name for each charging station should be unique within an urban region where the charging station is located, so as to avoid a situation in which the user searches out two or more station sites having a duplicated name in the urban area, and avoid inconvenience to the user caused by the situation;

based on this principle, the public management system platform has system settings for ensuring the uniqueness of the names of the charging stations and the charging piles, and has a name for each set station pile marked at a city level;

2. easy to remember

the station sites should be named according to names of nearby places, areas, communities, villages, streets, real estates, scenic spots, museums, hospitals, schools, commercial squares, subway stations, railway stations and bus stations, which are easy to remember.

According to some embodiments, the operation 2 includes:

1. identifying, by the system, the operator based on management units according to a front-end payment request that is transmitted from a front end of the system, which specifically include:

the user initiates charging after placing an order with a prepayment through an APP, and the system identifies the management unit of the operator, and further identifies the operator according to the front-end payment request;

when the operator accesses the system, the public management platform system associates the charging station with an management unit, and associates the operator with the management unit, wherein each management unit is unique; the system makes an identifier for the management unit and also marks the associated operator as well as charging station; after the user places the order on the charging pile for charging, the system identifies the operator matching the charging pile according to the identifier;

2. determining whether multi-operator direct payment is enabled for the operator, which specifically include:

when the operator connects the charging station to the system platform, the relevant management unit is set, if an operating mode of the operator bound with the management unit is a dividend settlement mode, it is determined that the operator of the charging station does not have the multi-operator direct payment enabled; and if the operating mode of the operator bound with the management unit is a mode of multi-operator direct payment, it is determined that the charging station has the multi-operator direct payment enabled;

3. if the operator does not have the multi-operator direct payment enabled, paying the money to the platform, so that the money is settled by the platform with the operator after a certain number of working days, which specifically include:

if the operator does not have the multi-operator direct payment enabled, it is necessary for financial staff to settle with the operator regularly according to a dividend rule through the platform system;

4. if the operator has the multi-operator direct payment enabled, determining whether the user performs a settlement payment or a prepayment, which specifically include:

the user must pay the prepayment in order to place an order for charging, and the system settles the payment after the charging finishes; and when the platform performs multi-operator direct payment, it is determined whether the money is a prepayment or a settlement payment;

5. if the user performs the settlement payment, determining whether a settlement fee is more than a prepayment fee, which specifically include:

if the settlement fee is more than the prepayment fee, the user's arrearage is recorded and the payment completes; if the settlement fee is less than the prepayment fee, the payment completes; the system calculates the difference between the settlement fee and the prepayment fee after the payment completes, and a refund request is initiated on a corresponding channel; after the refund, a third-party platform informs a business system whether the refund is successful, if the refund fails, the system tells a reason that causes the failure, and a further process is performed accordingly;

6. performing, by the user, the prepayment, which specifically include:

querying payment parameters of a corresponding channel corresponding to the operator, visiting a gateway of the corresponding channel, and generating a prepayment order, then encapsulating and encrypting the payment parameters and returning the resulting payment parameters to a front end; then the front end submitting a payment request to a third party based on the payment parameters returned by a back end, inputting payment password, paying the order amount to the operator and completing the payment; receiving, by the back end, a payment callback from the third party and updating the status.

The payment method for the operators in the present disclosure includes various implementations, which are applicable to various possible situations, and the technical solution of the present disclosure is complete, detailed, practical, and convenient for programming and implementation.

According to some embodiments, the operation 3 includes:

1. financial inquiry

the operator can use a financial query function of the platform to query transaction details of a bound third-party account and query user accounts; the operator can query order status of the charging stations of the operator using an operating center;

2. invoice processing

the operator can view and process the user who needs to be invoiced, the operator can view detailed information of the users who have been invoiced and who have not been invoiced, the detailed information including applicant, invoice amount, header, shipping address, invoice number, and invoice order list contents;

3. cash withdrawal management

when a prepaid amount recharged by the user is more than an actual charging amount and the user applies for cash withdrawal, the operator can use the cash withdrawal management function to check details, record, processing status, application time and processing time of an order for which cash withdrawal is applied;

4. refunding

the operator can use the refunding function to view and process an inconsistency between an order amount and the actual amount, which is caused by the system or a settlement problem.

The financial management in the present disclosure, includes the financial inquiry, invoice processing, cash withdrawal management, cash withdrawal management and refunding to satisfy the various needs of the users, which can attract more operators to join in the public management platform for charging piles, such that the charging platform of the electric vehicles can better serve the users and the operators.

According to some embodiments, the operation 4 includes:

(1) order payment principle

the money spent by the user on the platform directly goes to a third-party payment platform account of the operator, without passing through the operating platform; and the user does not have any wallet information on the operating platform; the payment includes two modes: prepaid mode and postpaid mode;

(2) supported payment channels

an identity (ID) of an Application (APP) needs to be provided when the APP is to be bound with a WeChat payment account, since the APP has only one APPID number, the APP can only be bound with one WeChat payment account; therefore, WeChat payment cannot support payment to multiple operator accounts in a same APP, that is, the WeChat payment cannot implement direct transfer of the user's money to the operator's account; the platform only supports a payment access of Alipay and UnionPay;

(3) Prepayment process

the user pays the prepayment fee to the operator payment account before charging, and then an excess fee is refunded to the user, according to an actual spend, in an original way for payment; in this case, the Alipay and UnionPay account of the operator need to enable a refunding-in-original-way function;

when the user pays the prepayment fee by Alipay or UnionPay, then starts charging and completes charging, the system refunds a difference between an actual charging fee and the prepayment fee to the user, and the system refunds the money to an account that has paid the prepayment fee;

when the user does not start charging after paying the prepayment fee, then the user can select to cancel the order, the prepayment fee will be refunded to the user in the original way for payment;

(4) refunding in the original way for payment

1. principle for refunding in the original way for payment

each refund is only for one order;

the user can initiate a refund, one refund can only be initiated for an order, and an amount to be refunded is a remaining amount of the account;

2. realization of refunding in the original way for payment

when the user places an order through an Alipay or UnionPay account, the system records a bank account number of the order placed, and when the user initiates a refund request for the order, the system automatically settles the refundable amount, which the user cannot modify; then the user sends the refund request, and the system extracts the bank account number of the refunded order, encrypts refund parameters and sends the encrypted refund parameters to Alipay or UnionPay; Alipay or UnionPay decrypts the encrypted refund parameters after receiving the encrypted parameters and the bank account number, and compares refund amount with the order amount obtained through the bank account, then determines whether the refund amount exceeds the order amount, if it does not exceed, Alipay or UnionPay will refund the refund amount to an bank account corresponding to the bank account number, otherwise no refund will be made; after completing the whole process, Alipay or UnionPay will send processing results to the system;

The settlement method in the present disclosure includes the existing common technical means to meet the various needs of users, and further include the prepayment function and a refund option. The technical solution of the present disclosure is complete, detailed, practical, and convenient for programming and implementation, such that the charging platform of the electric vehicles can better serve the users and the operators.

According to some embodiments, during the payment through Alipay and UnionPay, the user mainly relies on payment security measures of a third-party institution to ensure payment security; when payment data are interfaced between the platform and the third-party, RSA algorithms and certificates are used to ensure security of the payment data;

(1) payment security of Alipay

during payment, Alipay is supported by an advanced risk control system to ensure payment security, and its Payment Security Center guarantees user accounts, transactions, and privacy; wherein payment security measures include: dual passwords, multiple protections from security controls, round-the-clock abnormal operation detection performed by Alipay's risk control system, and mobile phone dynamic passwords; when the payment data are interfaced between the platform and Alipay, RSA algorithms and certificates are used to ensure security of the payment data;

(2) payment security of UnionPay

payment security of UnionPay is guaranteed.

The disclosure ensures user payment security through various security measures, and the technical solution of the present disclosure is complete, detailed and convenient for programming and implementation, such that the charging platform of the electric vehicles can better serve the users and the operators.

According to some embodiments, the payment security of UnionPay is guaranteed by the following three means:

1. security for page input and transmission

a security control is embedded in a password input box of the UnionPay online payment page, which can effectively prevent keyboard information from being stolen and protect security of a cardholder's password; after collecting payment information, the UnionPay online payment system transmits, through a dedicated line, encrypted payment information encrypted by a key to a card issuer for information verification;

2. identity authentication

a quick mode of UnionPay online payment supports three identity authentication ways: static authentication, dynamic authentication, and authentication through certificates;

3. risk management system monitoring

a risk management monitoring system can perform quasi real-time card monitoring, and can prompt the card issuer of large-amount or suspicious transactions; the system can also monitor merchants, thus an acquirer needs to correctly submit merchant information and a Merchant Category Code (MCC) reflecting business scope of the merchant according to risk management requirements of the UnionPay; in addition, the system can also notify the acquirer of risk indicators or send relevant information files; when performing data transmission, the platform system and UnionPay use a certificate to encrypt transmitted data for data security protection. The disclosure ensures payment security of the UnionPay users through various security measures, and the technical solution of the present disclosure is complete, detailed and convenient for programming and implementation, such that the charging platform of the electric vehicles can better serve the users and the operators.

(5) abnormal settlement

the user prepays a fixed fee during the charging process, when the charging fee reaches the prepaid fee, the platform system issues a stop charging instruction, if the charging pile fails to stop in time, the charging fee will exceeds the user's prepaid fee, and the excess fee shall be borne by the operator.

Compared with the prior art, the present disclosure has the beneficial effects as follow.

The multi-operator direct payment refers to a payment method for the operators where the platform is hosted for the multiple operators. The multi-operator direct payment allows the payment to be directly paid to the actual charging account of the operators through dynamically-targeted payment techniques, without the need for secondary clearing and settlement, which also improves the timeliness of fund arrival, further achieves and promotes the interconnection among the multiple operators. In the traditional operating mode, the money firstly arrives at the platform and is then transferred to the operators, causing the problems of slow fund arrival, extra fees for transfer, and being not subject to the operators' control. The operator direct payment technology focuses on small and micro operators, where the money is directly transferred to the operator's account without going through the platform, then the money can be received in real time without the needs to pay extra fees; furthermore, there is also no concern that the platform does not give the received fees to the operators. The technical solutions according to embodiment of the present disclosure can attract more operators to join in the public management platform for charging piles, such that the charging platform of the electric vehicles can better serve the users and the operators.

### BRIEF DESCRIPTION OF DRAWINGS

FIG. 1 is an overall flowchart of multi-operator direct payment according to an embodiment of the present disclosure;

FIG. 2 is a flowchart of the prepayment according to an embodiment of the present disclosure;

FIG. 3 is a flowchart of the refund according to an embodiment of the present disclosure.

### DETAILED DESCRIPTION

In order to make the objectives, technical solutions, and advantages of the present disclosure clearer, the disclosure is described in further detail with reference to the drawings and embodiments below. It should be understood that these embodiments hereinafter only contribute to a more thorough understanding of the disclosure, and should not be construed as a limit to the present disclosure.

In contrary, any substitution, modification, equivalent method, and solution based on the spirit and scope as defined by the claims, belongs to the present disclosure. Further, in order to give the public a better understanding of the present disclosure, the description below elaborates some specific details. For those skilled in the art, the present disclosure can be fully understood even without the description of these specific details.

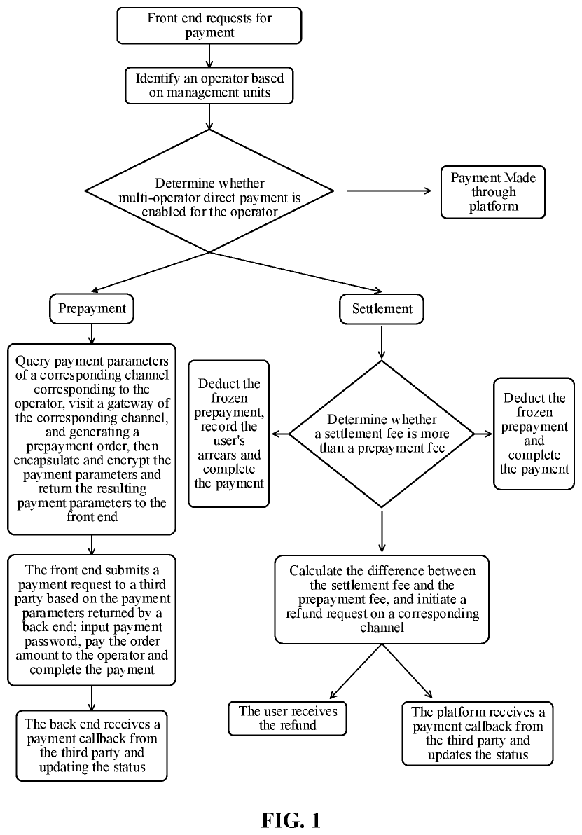

As shown in FIGS. 1-3, a multi-operator direct payment system of a public operating service platform for electric vehicles, includes the following operations 1 to 5.

In an operation 1, operators access the public platform, which include (1) to (3) as follow.

(1) Data reviewing

Specifically, when each operator accesses the platform, the operator firstly submits relevant data about the operator's enterprise, such as business license, account opening permit, a number of charging stations and locations of charging stations, to staff of a public management platform; after the relevant data is reviewed and approved by the staff of the public management platform, a management unit belonging to the operator is established through a public management platform background system for electric vehicles, wherein the management unit is unique, and only one management unit can be established for one operator.

(2) Charging station accessing

Specifically, after the operator accesses the platform, the operator inputs relevant information about the charging stations through the public management platform background system;

the operator firstly selects a management unit to associate the charging stations with the selected management unit;

the operator inputs names of station sites to distinguish different station sites of the operator; wherein the station sites should be named according to the following principles.

1. Regional uniqueness

The name for each charging station should be unique within an urban region where the charging station is located, so as to avoid a situation in which the user searches out two or more station sites having a duplicated name in the urban area, and avoid inconvenience to the user caused by the situation.

Based on this principle, the public management system platform has system settings for ensuring the uniqueness of the names of the charging stations and the charging piles, and has a name for each set station pile marked at a city level.

2. Easy to remember

The station sites should be named according to names of nearby places, areas, communities, villages, streets, real estates, scenic spots, museums, hospitals, schools, commercial squares, subway stations, railway stations and bus stations, which are easy to remember.

The operator inputs position information of the charging stations after information about interested party of the station site is input, wherein latitude, longitude and detailed address of the charging stations must be accurate to ensure accuracy of a map for charging stations.

After establishment of the charging stations, the charging piles are set through a pile management function, so that a user can find the charging pile and place an order for charging through an application (APP) on a mobile phone of the user.

(3) Binding of the operator and the management unit

Specifically, the access of the management unit and the charging piles is finished, the operator is added into the public platform, and the operator is associated with the management unit.

In an operation 2, multi-operator direct payment process:

after the operator accesses the platform, a user can place an order for different charging piles through an application (APP), the money is paid directly to the operator's account without going through the platform, the specific process is shown in FIG. 1.

1. The system identifies the operator based on management units according to a front-end payment request that is transmitted from a front end of the system.

Specifically, the user initiates charging after placing an order with a prepayment through an APP, and the system identifies the management unit of the operator, and further identifies the operator according to the front-end payment request.

When the operator accesses the system, the public management platform system associates the charging station with an management unit, and associates the operator with the management unit, wherein each management unit is unique; the system makes an identifier for the management unit and also marks the associated operator as well as charging station; after the user places the order on the charging pile for charging, the system identifies the operator matching the charging pile according to the identifier.

2. It is determined whether multi-operator direct payment is enabled for the operator.

Specifically, when the operator connects the charging station to the system platform, the relevant management unit is set, if an operating mode of the operator bound with the management unit is a dividend settlement mode, it is determined that the operator of the charging station does not have the multi-operator direct payment enabled; and if the operating mode of the operator bound with the management unit is a mode of multi-operator direct payment, it is determined that the charging station has the multi-operator direct payment enabled.

3. If the operator does not have the multi-operator direct payment enabled, paying the money to the platform, so that the money is settled by the platform with the operator after a certain number of working days.

Specifically, if the operator does not have the multi-operator direct payment enabled, it is necessary for financial staff to settle with the operator regularly according to a dividend rule through the platform system.

4. If the operator has the multi-operator direct payment enabled, it is determined whether the user performs a settlement payment or a prepayment.

Specifically, the user must pay the prepayment in order to place an order for charging, and the system settles the payment after the charging finishes; and when the platform performs multi-operator direct payment, it is determined whether the money is a prepayment or a settlement payment.

5. If the user performs the settlement payment, it is determined whether a settlement fee is more than a prepayment fee.

Specifically, if the settlement fee is more than the prepayment fee, the user's arrearage is recorded and the payment completes; if the settlement fee is less than the prepayment fee, the payment completes; the system calculates the difference between the settlement fee and the prepayment fee after the payment completes, and a refund request is initiated on a corresponding channel; after the refund, a third-party platform informs a business system whether the refund is successful, if the refund fails, the system tells a reason that causes the failure, and a further process is performed accordingly,

6. The user performs the prepayment.

Specifically, payment parameters of a corresponding channel corresponding to the operator are queried, a gateway of the corresponding channel is visited, and a prepayment order is generated, then the payment parameters are encapsulated and encrypted and the payment parameters are returned to a front end; then the front end submits a payment request to a third party based on the payment parameters returned by a back end, a payment password is inputted, the order amount to the operator is paid and the payment is completed; the back end receives a payment callback from the third party and the status is updated.

In an operation 3, financial management of the operators is performed through 1 to 4.

1. Financial inquiry

Specifically, the operator can use a financial query function of the platform to query transaction details of a bound third-party account and query user accounts; the operator can query order status of the charging stations of the operator using an operating center.

2. Invoice processing

Specifically, the operator can view and process the user who needs to be invoiced, the operator can view detailed information of the users who have been invoiced and who have not been invoiced, the detailed information including applicant, invoice amount, header, shipping address, invoice number, and invoice order list contents.

3. Cash withdrawal management

Specifically, when a prepaid amount recharged by the user is more than an actual charging amount and the user applies for cash withdrawal, the operator can use the cash withdrawal management function to check details, record, processing status, application time and processing time of an order for which cash withdrawal is applied.

4. Refunding

Specifically, the operator can use the refunding function to view and process an inconsistency between an order amount and the actual amount, which is caused by the system or a settlement problem.

In an operation 4, settlement process for the operators includes (1) to (5).

(1) Order payment principle

Specifically, the money spent by the user on the platform directly goes to a third-party payment platform account of the operator, without passing through the operating platform; and the user does not have any wallet information on the operating platform.

The payment includes two modes: prepaid mode and postpaid mode.

(2) Supported payment channels

Specifically, an identity (ID) of an Application (APP) needs to be provided when the APP is to be bound with a WeChat payment account, since the APP has only one APPID number, the APP can only be bound with one WeChat payment account; therefore, WeChat payment cannot support payment to multiple operator accounts in a same APP, that is, the WeChat payment cannot implement direct transfer of the user's money to the operator's account; the platform only supports a payment access of Alipay and UnionPay.

(3) Prepayment process

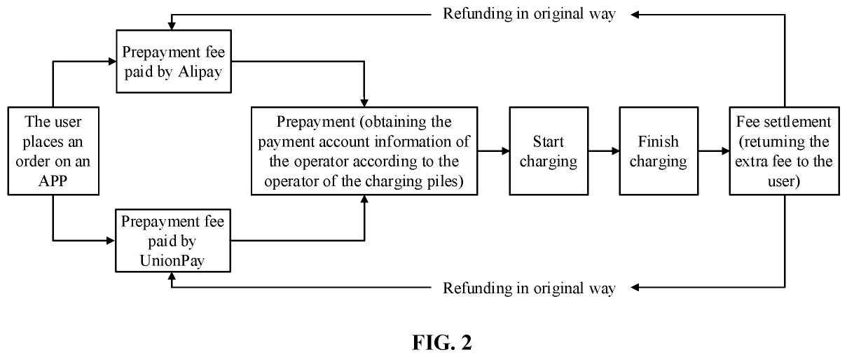

Specifically, the user pays the prepayment fee to the operator payment account before charging, and then an excess fee is refunded to the user, according to an actual spend, in an original way for payment; in this case, the Alipay and UnionPay account of the operator need to enable a refunding-in-original-way function, the specific process is shown FIG. 2.

When the user pays the prepayment fee by Alipay or UnionPay, then starts charging and completes charging, the system refunds a difference between an actual charging fee and the prepayment fee to the user, and the system refunds the money to an account that has paid the prepayment fee.

When the user does not start charging after paying the prepayment fee, then the user can select to cancel the order, the prepayment fee will be refunded to the user in the original way for payment.

(4) Refunding in the original way for payment, which specifically includes 1 to 2 below.

1. Principle for refunding in the original way for payment

Specifically, each refund is only for one order; and

the user can initiate a refund, one refund can only be initiated for an order, and an amount to be refunded is a remaining amount of the account.

2. Realization of refunding in the original way for payment

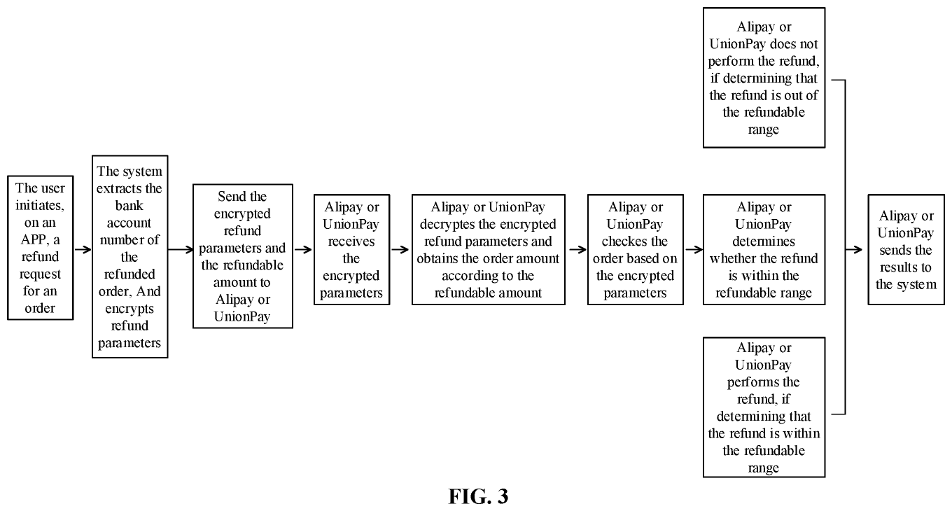

Specifically, when the user places an order through an Alipay or UnionPay account, the system records a bank account number of the order placed, and when the user initiates a refund request for the order, the system automatically settles the refundable amount, which the user cannot modify; then the user sends the refund request, and the system extracts the bank account number of the refunded order, encrypts refund parameters and sends the encrypted refund parameters to Alipay or UnionPay; Alipay or UnionPay decrypts the encrypted refund parameters after receiving the encrypted parameters and the bank account number, and compares refund amount with the order amount obtained through the bank account, then determines whether the refund amount exceeds the order amount, if it does not exceed, Alipay or UnionPay will refund the refund amount to an bank account corresponding to the bank account number, otherwise no refund will be made; after completing the whole process, Alipay or UnionPay will send processing results to the system, with reference to FIG. 3.

(5) Abnormal settlement

Specifically, the user prepays a fixed fee during the charging process, when the charging fee reaches the prepaid fee, the platform system issues a stop charging instruction, if the charging pile fails to stop in time, the charging fee will exceeds the user's prepaid fee, and the excess fee shall be borne by the operator;

In an operation 5, the payment security is ensured.

Specifically, during the payment through Alipay and UnionPay, the user mainly relies on payment security measures of a third-party institution to ensure payment security; when payment data are interfaced between the platform and the third-party, RSA algorithms and certificates are used to ensure security of the payment data.

(1) Payment security of Alipay

During payment, Alipay is supported by an advanced risk control system to ensure payment security, and its Payment Security Center guarantees user accounts, transactions, and privacy; wherein payment security measures include: dual passwords, multiple protections from security controls, round-the-clock abnormal operation detection performed by Alipay's risk control system, and mobile phone dynamic passwords; when the payment data are interfaced between the platform and Alipay, RSA algorithms and certificates are used to ensure security of the payment data.

(2) Payment security of UnionPay

The payment security of UnionPay is guaranteed by the following three means.

1. Security for page input and transmission

Specifically, a security control is embedded in a password input box of the UnionPay online payment page, which can effectively prevent keyboard information from being stolen and protect security of a cardholder's password; after collecting payment information, the UnionPay online payment system transmits, through a dedicated line, encrypted payment information enctryted by a key to a card issuer for information verification.

2. Identity authentication

Specifically, a quick mode of UnionPay online payment supports three identity authentication ways: static authentication, dynamic authentication, and authentication through certificates.

3. Monitoring risk management system

Specifically, a risk management monitors system can perform quasi real-time card monitoring, and can prompt the card issuer of large-amount or suspicious transactions; the system can also monitor merchants, thus an acquirer needs to correctly submit merchant information and a Merchant Category Code (MCC) reflecting business scope of the merchant according to risk management requirements of the UnionPay; in addition, the system can also notify the acquirer of risk indicators or send relevant information files.

When performing data transmission, the platform system and UnionPay use a certificate to encrypt transmitted data for data security protection.

The above description is only the preferred embodiments of the present invention and is not intended to limit the present disclosure. Any modification, replacement, and improvement made based on the spirit and principle of the present disclosure should be included in the protection scope of the present disclosure.

1. A multi-operator direct payment system of a public operating service platform for electric vehicles, comprising:
a memory storing processor-executable instructions; and
a processor arranged to execute the stored processor-executable instructions to perform operations of:
an operation 1 of accessing, by operators, the public platform;
an operation 2 of placing, by users, orders on different charging piles after the operators access the public operating service platform, money related to each order being directly paid to an account of a corresponding operator;
an operation 3 of performing financial management of the operators;
an operation 4 of settling with the operators.

2. The multi-operator direct payment system of a public operating service platform for electric vehicles according to claim 1, wherein the operation 1 comprises:
(1) data reviewing, which specifically comprises:
when each operator accesses the platform, firstly submitting, by the operator, relevant data about the operator's enterprise, such as business license, account opening permit, a number of charging stations and locations of charging stations, to staff of a public management platform; after the relevant data is reviewed and approved by the staff of the public management platform, establishing a management unit belonging to the operator through a public management platform background system for electric vehicles, wherein the management unit is unique, and only one management unit can be established for one operator;
(2) charging station accessing, which specifically comprises:
after the operator accesses the platform, inputting, by the operator, relevant information about the charging stations through the public management platform background system;
firstly selecting, by the operator, a management unit to associate the charging stations with the selected management unit;
inputting, by the operator, names of station sites to distinguish different station sites of the operator;
inputting, by the operator, position information of the charging stations after information about interested party of the station site is input, wherein latitude, longitude and detailed address of the charging stations must be accurate to ensure accuracy of a map for charging stations;
after establishment of the charging stations, setting the charging piles through a pile management function, so that a user can find the charging pile and place an order for charging through an application (APP) on a mobile phone of the user;
(3) binding of the operator and the management unit, which specifically comprises: finishing the access of the management unit and the charging piles, adding the operator into the public platform, and associating the operator with the management unit.

3. The multi-operator direct payment system of a public operating service platform for electric vehicles according to claim 2, wherein the station sites should be named according to the following principles:
1. regional uniqueness
the name for each charging station should be unique within an urban region where the charging station is located, so as to avoid a situation in which the user searches out two or more station sites having a duplicated name in the urban area, and avoid inconvenience to the user caused by the situation;
based on this principle, the public management system platform has system settings for ensuring the uniqueness of the names of the charging stations and the charging piles, and has a name for each set station pile marked at a city level;
2. easy to remember
the station sites should be named according to names of nearby places, areas, communities, villages, streets, real estates, scenic spots, museums, hospitals, schools, commercial squares, subway stations, railway stations and bus stations, which are easy to remember.

4. The multi-operator direct payment system of a public operating service platform for electric vehicles according to claim 1, wherein the operation 2 comprises:
1. identifying, by the system, the operator based on management units according to a front-end payment request that is transmitted from a front end of the system, which specifically comprises:
the user initiates charging after placing an order with a prepayment through an APP, and the system identifies the management unit of the operator, and further identifies the operator according to the front-end payment request;
when the operator accesses the system, the public management platform system associates the charging station with an management unit, and associates the operator with the management unit, wherein each management unit is unique; the system makes an identifier for the management unit and also marks the associated operator as well as charging station; after the user places the order on the charging pile for charging, the system identifies the operator matching the charging pile according to the identifier;
2. determining whether multi-operator direct payment is enabled for the operator, which specifically comprises:
when the operator connects the charging station to the system platform, the relevant management unit is set, if an operating mode of the operator bound with the management unit is a dividend settlement mode, it is determined that the operator of the charging station does not have the multi-operator direct payment enabled; and if the operating mode of the operator bound with the management unit is a mode of multi-operator direct payment, it is determined that the charging station has the multi-operator direct payment enabled;
3. if the operator does not have the multi-operator direct payment enabled, paying the money to the platform, so that the money is settled by the platform with the operator after a certain number of working days, which specifically comprises:
if the operator does not have the multi-operator direct payment enabled, it is necessary for financial staff to settle with the operator regularly according to a dividend rule through the platform system;
4. if the operator has the multi-operator direct payment enabled, determining whether the user performs a settlement payment or a prepayment, which specifically comprises:
the user must pay the prepayment in order to place an order for charging, and the system settles the payment after the charging finishes; and when the platform performs multi-operator direct payment, it is determined whether the money is a prepayment or a settlement payment;
5. if the user performs the settlement payment, determining whether a settlement fee is more than a prepayment fee, which specifically comprises:
if the settlement fee is more than the prepayment fee, the user's arrearage is recorded and the payment completes; if the settlement fee is less than the prepayment fee, the payment completes; the system calculates the difference between the settlement fee and the prepayment fee after the payment completes, and a refund request is initiated on a corresponding channel; after the refund, a third-party platform informs a business system whether the refund is successful, if the refund fails, the system tells a reason that causes the failure, and a further process is performed accordingly;
6. performing, by the user, the prepayment, which specifically comprises:
querying payment parameters of a corresponding channel corresponding to the operator, visiting a gateway of the corresponding channel, and generating a prepayment order, then encapsulating and encrypting the payment parameters and returning the resulting payment parameters to a front end; then the front end submitting a payment request to a third party based on the payment parameters returned by a back end, inputting payment password, paying the order amount to the operator and completing the payment; receiving, by the back end, a payment callback from the third party and updating the status.

5. The multi-operator direct payment system of a public operating service platform for electric vehicles according to claim 1, wherein the financial management in the operation 3 comprises:
1. financial inquiry
the operator can use a financial query function of the platform to query transaction details of a bound third-party account and query user accounts; the operator can query order status of the charging stations of the operator using an operating center;
2. invoice processing
the operator can view and process the user who needs to be invoiced, the operator can view detailed information of the users who have been invoiced and who have not been invoiced, the detailed information including applicant, invoice amount, header, shipping address, invoice number, and invoice order list contents;
3. cash withdrawal management
when a prepaid amount recharged by the user is more than an actual charging amount and the user applies for cash withdrawal, the operator can use the cash withdrawal management function to check details, record, processing status, application time and processing time of an order for which cash withdrawal is applied;
4. refunding
the operator can use the refunding function to view and process an inconsistency between an order amount and the actual amount, which is caused by the system or a settlement problem.

6. The multi-operator direct payment system of a public operating service platform for electric vehicles according to claim 1, wherein the operation 4 of settling with the operator comprises:
(1) order payment principle
the money spent by the user on the platform directly goes to a third-party payment platform account of the operator, without passing through the operating platform; and the user does not have any wallet information on the operating platform; the payment includes two modes: prepaid mode and postpaid mode;
(2) supported payment channels
an identity (ID) of an Application (APP) needs to be provided when the APP is to be bound with a WeChat payment account, since the APP has only one APPID number, the APP can only be bound with one WeChat payment account; therefore, WeChat payment cannot support payment to multiple operator accounts in a same APP, that is, the WeChat payment cannot implement direct transfer of the user's money to the operator's account; the platform only supports a payment access of Alipay and UnionPay;
(3) prepayment process
the user pays the prepayment fee to the operator payment account before charging, and then an excess fee is refunded to the user, according to an actual spend, in an original way for payment; in this case, the Alipay and UnionPay account of the operator need to enable a refunding-in-original-way function;
when the user pays the prepayment fee by Alipay or UnionPay, then starts charging and completes charging, the system refunds a difference between an actual charging fee and the prepayment fee to the user, and the system refunds the money to an account that has paid the prepayment fee;
when the user does not start charging after paying the prepayment fee, then the user can select to cancel the order, the prepayment fee will be refunded to the user in the original way for payment;
(4) refunding in the original way for payment
1. principle for refunding in the original way for payment
each refund is only for one order;
the user can initiate a refund, one refund can only be initiated for an order, and an amount to be refunded is a remaining amount of the account;
2. realization of refunding in the original way for payment
when the user places an order through an Alipay or UnionPay account, the system records a bank account number of the order placed, and when the user initiates a refund request for the order, the system automatically settles the refundable amount, which the user cannot modify; then the user sends the refund request, and the system extracts the bank account number of the refunded order, encrypts refund parameters and sends the encrypted refund parameters to Alipay or UnionPay; Alipay or UnionPay decrypts the encrypted refund parameters after receiving the encrypted parameters and the bank account number, and compares refund amount with the order amount obtained through the bank account, then determines whether the refund amount exceeds the order amount, if it does not exceed, Alipay or UnionPay will refund the refund amount to an bank account corresponding to the bank account number, otherwise no refund will be made; after completing the whole process, Alipay or UnionPay will send processing results to the system;
(5) abnormal settlement
the user prepays a fixed fee during the charging process, when the charging fee reaches the prepaid fee, the platform system issues a stop charging instruction, if the charging pile fails to stop in time, the charging fee will exceeds the user's prepaid fee, and the excess fee shall be borne by the operator.

7. The multi-operator direct payment system of a public operating service platform for electric vehicles according to claim 6, wherein during the payment through Alipay and UnionPay, the user mainly relies on payment security measures of a third-party institution to ensure payment security; when payment data are interfaced between the platform and the third-party, RSA algorithms and certificates are used to ensure security of the payment data;
(1) payment security of Alipay
during payment, Alipay is supported by an advanced risk control system to ensure payment security, and its Payment Security Center guarantees user accounts, transactions, and privacy; wherein payment security measures comprise: dual passwords, multiple protections from security controls, round-the-clock abnormal operation detection performed by Alipay's risk control system, and mobile phone dynamic passwords; when the payment data are interfaced between the platform and Alipay, RSA algorithms and certificates are used to ensure security of the payment data;
(2) payment security of UnionPay
payment security of UnionPay is guaranteed.

8. The multi-operator direct payment system of a public operating service platform for electric vehicles according to claim 7, wherein the payment security of UnionPay is guaranteed by the following three means:
1. security for page input and transmission
a security control is embedded in a password input box of the UnionPay online payment page, which can effectively prevent keyboard information from being stolen and protect security of a cardholder's password; after collecting payment information, the UnionPay online payment system transmits, through a dedicated line, encrypted payment information encrypted by a key to a card issuer for information verification;
2. identity authentication
a quick mode of UnionPay online payment supports three identity authentication ways: static authentication, dynamic authentication, and authentication through certificates;
3. risk management system monitoring
a risk management monitoring system can perform quasi real-time card monitoring, and can prompt the card issuer of large-amount or suspicious transactions; the system can also monitor merchants, thus an acquirer needs to correctly submit merchant information and a Merchant Category Code (MCC) reflecting business scope of the merchant according to risk management requirements of the UnionPay; in addition, the system can also notify the acquirer of risk indicators or send relevant information files; when performing data transmission, the platform system and UnionPay use a certificate to encrypt transmitted data for data security protection.
